(19) United States
(12) Patent Application Publication
(10) Pub. No.: US 2021/0012266 A1
(43) Pub. Date: Jan. 14, 2021

(54) AUGMENTED MANAGEMENT SYSTEM AND METHOD

(71) Applicant: Raven Telemetry Inc., Ottawa (CA)

(72) Inventors: Braden STENNING, Ottawa (CA); Martin CLOAKE, Ottawa (CA); Andrew BLANCHARD, Ottawa (CA)

(21) Appl. No.: 16/982,320

(22) PCT Filed: Mar. 25, 2019
(86) PCT No.: PCT/CA2019/050361

§ 371 Date: Sep. 18, 2020

Related U.S. Application Data
(60) Provisional application No. 62/647,878, filed on Mar. 26, 2018.

(51) Int. Cl. G06Q 10/06; G06Q 50/04; G06N 20/00

(52) U.S. Cl. CPC G06Q 10/06398; G06N 20/00; G06Q 50/04

(57) ABSTRACT

An augmented management system and method for guiding leader standard work in a manufacturing environment. A leader location monitor collects leader location data and a leader action monitor for collecting leader action data. A machine tap collects performance data and the collected data is stored in one or more databases. A prescriptive analytics engine analyzing the leader behavior performance and suggests a change in leader behavior that will contribute to process health.

### FIELD OF THE INVENTION

The present invention pertains to a system and method of augmented management for guiding leader behaviour. In particular, the present system and method can be used to quantify and augment Leader Standard Work (LSW) in a manufacturing environment and contribute to process health.

### BACKGROUND

Lean manufacturing process optimization aims to engage people at all levels of an organization to cooperatively contribute to the overall improvement of efficiency of an organization. Learning how to work smarter within a manufacturing organization means understanding where losses occur and working together at all levels in an organization to identify opportunities for process optimization and improved operational health. Quantifying the behavior of contributors to the operational health of the manufacturing environment provides an opportunity to understand how the performance of some operators and leaders leads to greater productivity and greater operational health, and enables an organization to teach those positive behaviors to other members of the manufacturing team.

On a manufacturing floor, operator or standard work is the work of machine operators, engineers, and technicians to manufacture products and maintain the equipment required to make those products. Leader standard work, in contrast, is the managerial, or overseeing work done by a supervisor or leader in the manufacturing environment. The behavior of supervisors and leaders on a manufacturing floor can have a significant effect on morale, safety, and overall team productivity. Further, it is clear that the management behaviors of some supervisors result in more positive health benefits to the organization and that some leaders are more effective than others. In a manufacturing environment, these positive health benefits can include greater team safety, a decrease in workplace injuries, less machine down time, greater team member satisfaction, increased team engagement, greater employee satisfaction, increased efficiency, lower defect or mistake rates, and greater overall productivity. However, the quality of leader standard work is difficult to evaluate and historically has been based on a combination of anecdotal reports from team members and overall data on shift productivity. Understanding and identifying the work behaviors of leaders as they conduct leader standard work which results in improvements and optimization of standard work can provide actionable guidance to the organization regarding overall leader behavior improvement and enable overall gains in operational health and manufacturing productivity.

Various systems are known for tracking the attendance of an individual in a workplace. For example, U.S. Pat. No. 9,805,342 to Dickerson et al. describes a system including a location tracking system that detects a presence of a portable electronic device carried by an individual, a time clock system that records a registration time of the individual at the workplace, and a controller to record the registration time.

In a recent organizational health survey of 189,000 people at 81 geographically and industrially diverse organizations (Decoding leadership: What really matters; McKinsey Quarterly, January 2015), four leader behaviors emerged as contributing to 89% of leader effectiveness: supportiveness of the leader to team members; focus on results; seeking different perspectives; and solve problems effectively. The study results suggest that the more consistent leaders and managers are in these behaviors, the more they turn the behaviors into a new standard for how they work, and the more continuous improvement they are likely to achieve. However identifying the exact behaviors that contribute to focusing on results, seeking different perspectives, and solving problems effectively can be challenging to pinpoint for leaders and is more often evaluated as a general feeling of the team member, when in reality it is what the leader does on a daily basis (leader behavior) that results in performance gains.

There remains a need to track the workplace behavior of leaders to be able to quantify leader standard work that has a positive contribution to operational health.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method of augmented management for guiding leader behaviour in a manufacturing environment. In particular, the present system and method can be used to quantify and augment Leader Standard Work in a manufacturing environment and improve process health.

In an aspect there is provided an augmented management system comprising: a leader location monitor for collecting leader location data in a manufacturing environment; a leader location monitor for collecting leader location data in a manufacturing environment; a machine tap for collecting machine data; a database of performance data for storing the machine data and context data; a database of leader behavior for storing the leader location data; a prescriptive analytics engine for analyzing the leader location data and the performance data; and an alert engine for providing an alert to the leader to guide leader behavior.

In an embodiment of the system, the leader location data comprises at least one of leader location in the manufacturing environment, duration of time spent at the location, speed of movement through the manufacturing environment, path of movement through the manufacturing environment, time of movement, and identification of at least one other team member in the manufacturing environment.

In another embodiment of the system, the alert is delivered to one or more of a laptop, smartphone, mobile device, augmented reality device, conversational voice assistant, or optical feedback device.

In another embodiment, the system further comprises an input device for tagging the leader location data to provide additional information about leader behavior.

In another embodiment of the system, the alert engine uses at least one of machine learning and artificial intelligence.

In another embodiment of the system, the prescriptive analytics engine uses at least one of machine learning and artificial intelligence.

In another embodiment of the system, the leader location monitor comprises a trackable leader mobile device and at least three anchor nodes in the manufacturing environment.

In another embodiment, the system further comprises one or more team member location monitors.

In another embodiment of the system, the alert is provided to the leader on one of a task list, action card, floor plan map, and queued audio list.

In another embodiment, the system further comprises a leader action monitor for collecting leader action data.

In another aspect there is provided a method for augmented management comprising: collecting leader location data for a leader in a manufacturing environment; collecting performance data for the manufacturing environment; storing the leader location data and the performance data in at least one database; analyzing the leader location data and the performance data in a prescriptive analytics engine; and generating an alert to guide leader behavior, wherein the guidance results in a change to process health of the manufacturing environment.

In an embodiment of the method, generating an alert sends out an alert in real-time.

In another embodiment of the method, generating an alert comprises delivering an alert to one or more of a laptop, smartphone, mobile device, augmented reality device, conversational voice assistant, or optical feedback device.

In another embodiment, the method further comprises recording leader reaction time for responding to an alert.

In another embodiment of the method, the prescriptive analytics engine analyzes the leader behavior data and the performance data using at least one of machine learning and artificial intelligence.

In another embodiment, the method further comprises tracking location of one or more team members in the manufacturing environment.

In another embodiment of the method, the leader location data comprises at least one of leader location in the manufacturing environment, duration of time spent at the location, speed of movement through the manufacturing environment, path of movement through the manufacturing environment, time of movement, and identification of at least one other team member in the manufacturing environment.

In another embodiment, the method further comprises collecting leader action data; and analyzing the leader action data in the prescriptive analytics engine, wherein the leader action data comprises at least one of time and timing of report reading, timing and duration of meetings, scripts used during meetings, amount of time spent on the manufacturing floor during a shift, time of huddle during shift, duration of huddle, amount of time spent on one-on-one mentoring, and amount of time in a huddle spent on particular aspects of process health.

In another embodiment, the method further comprises limiting the number of generated alerts to below a daily threshold limit.

In another embodiment of the method, the alert is generated based on threshold opportunity for the alert.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a schematic of an augmented management system;

FIG. 2 is a flowchart depicting data collection in an augmented management system;

FIG. 3 is a flowchart depicting a method of generating a leader alert in an augmented management system;

FIG. 4 is a floor plan view of a manufacturing floor with an overlaid leader location pattern;

FIG. 5 is a floor plan view of a manufacturing floor with an overlaid grid;

FIG. 6A is a graph of short term result focus on business loss over time;

FIG. 6B is a graph of process health focus on business loss over time;

FIG. 7 is a graph of performance over time as a result of a process improvement;

FIG. 8A is a set of pie charts for four leaders showing amount of time spent on each of a set of leader activities;

FIG. 8B is a pie chart breakdown of non-core activities of Leader 3 from FIG. 8A;

FIG. 9 is an example board or screen for a huddle;

FIG. 10A is a set of leader action cards for non-urgent leader actions;

FIG. 10B is an urgent leader action card for an urgent leader action;

FIG. 11 is an example leader performance report; and

FIG. 12 is a graph showing a distribution of running time between wheel dressings.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “leader” as used herein refers to a team lead, supervisor, or group leader responsible for a team or group. In a manufacturing environment, the leader can be a manufacturing team lead responsible for a team of, for example, one or more machine operators, technicians, material handling staff, quality assurance staff, maintenance staff, process engineers, and safety officers. A leader can also be a production manager responsible for a group of team leaders, or a management officer responsible for a group of production managers. In a manufacturing environment, the term “leader” is used to designate any person who has other members of the organization reporting to them.

The term “leader standard work” as used herein refers to the work done by a leader or supervisor in a manufacturing environment. Leader standard work can include but is not limited to checking in on machine operators, ensuring maintenance calls are responded to in a reasonable amount of time, leading reflection meetings, identifying and providing appropriate training to operators and team members, mentoring, leading team huddles, Andon response (the response to alerts on the manufacturing floor triggered by operators), one-on-one meetings with team members or subordinates, meetings with supervisory teams, hosting daily/weekly/monthly management meetings, ensuring quality of product, scheduling, staff allocation, performance reviews, and reading reports.

The term “leader behavior data” as used herein refers to quantified leader behavior, which includes leader location data and leader action data. Leader location data is data pertaining to location and duration of movements of a leader in an environment. Leader action data is data pertaining to leader interaction with team members and the environment, both physical and electronic. Some non-limiting examples of leader behavior data include but are not limited to duration of time spent in a location, time and timing of report reading, timing and duration of meetings, scripts used during meetings, amount of time spent on the manufacturing floor during a shift, time of huddle during shift, duration of huddle, amount of time spent on one-on-one mentoring, amount of time in huddle focused on safety or performance, and amount of time in a huddle spent on particular aspects of process health.

The term “machine data” as used herein refers to data pertaining to the status of a machine on a manufacturing floor. Examples of machine data can include but is not limited to, up-time, down time, counts (number of units or quantity of production over time), identification of serial numbers or work orders, SKU data, rates, error codes, timestamping, measurements of specific signals such as power consumption, acoustic information, temperature, motion, light, sensor data, machine running speed, machine sensor data, machine data collected by a machine operator, and a combination thereof. Machine data can be collected by a sensor, solenoid, or by an operator.

The term “context data” as used herein refers to any data pertaining to the identification of the historical and current conditions under which a machine or operator is running. Context data can comprise but is not limited to identification of the part being manufactured, step of manufacturing, identification of the operator at the machine, batch information, information on the primary materials being processed by the machine, work order identification, machine task in progress, and maintenance history of the machine. Context data can be collected from, for example, an enterprise resource management system, a machine tap, or operator or leader input.

The term “performance data” as used herein includes machine data and context data, and comprises data pertaining to the performance or productivity of a machine (measured using machine data), operator, team, or part or whole of a manufacturing organization. Performance data can be measured using a variety of metrics selected and prioritized by the organization. Some non-limiting examples of the metrics by which performance data can be measured are safety, productivity, number or severity of workplace injuries, machine down time, employee satisfaction, employee turnover, team efficiency, defect or mistake rate, cycle time, work-in-progress age, and Overall Equipment Effectiveness (OEE).

The term “process health” as used herein refers to a quantifiable measurement of the efficiency, productivity, and/or sustainability of an industrial process. Process health is measured using one or more metrics which include but are not limited to incidence of workplace injury, machine down time, team engagement, employee satisfaction, product quality, defect or mistake rate, and productivity.

Described is an augmented management system and method for quantifying and supporting Leader Standard Work (LSW) in an organization. By measuring the performance data of an operator or team under the supervision of a manufacturing leader and correlating the effect of leader behavior and different leader practices on organizational health, the present system and method can result in guidelines for best practices in LSW. In particular, the effect of different leader practices on operational health and/or organizational performance can be tracked and real-time analytics on organizational performance can provide real-time guidance for leaders to implement best practices at the time they are most needed, contributing to improved process performance.

To implement process-focused change leaders must have a mindset to make and sustain change in the organization. This means being personally committed to the goal of improving the organization and modelling the personal commitment to others in the organization. By maintaining discipline to the process, at turning points throughout the transformation, leaders must hold true to following the process of transformation with the belief that the effort will prove worthwhile. Finally, leaders must be role models of the use of standard work to stay consistent and train future leaders. All of these behaviors can be quantified and correlated using the present system and method to identify which leader behaviors most contribute to improvements in process health and provide data-based guidance for leaders to implement the desired organizational change. In particular, by tracking real-time leader action and location and comparing this behavior with process and context data, a quantification of contributions of leader standard work to performance of an operator or team can be made. Organizational health and performance improvements can thus be quantified and correlated to leader behavior and provide organizational improvement guidelines to improve leader standard work for individual leaders and leaders across the organization and thereby improve operational health of the manufacturing organization. By collecting data on leader standard work, direction can also be provided for leaders on the timing and execution of certain tasks on the floor which have been shown to improve the quality of leader standard work, and thus improve manufacturing output and/or quality. Opportunities can also be found to improve process health in the organization, where an opportunity is an identified loss that can be mitigated or minimized through appropriate action.

Team productivity is based on the collective contributions of each member of the team; understanding how leader behavior contributes to the effectiveness of the team can suggest process improvements to improve the performance of each member of the team, and thus of the team as a whole. Real-time prescriptive analytics interprets manufacturing floor, machine, context, and operator data, and can suggest intelligent actions to operators, supervisors, and managers for immediate action and impact. Prescriptive analytics in manufacturing can further lead to, for example, better decision making and problem solving, increased leadership involvement, improved productivity for operators and managers, and improved overall productivity. By collecting real-time data about machine and operator function and productivity, the present system and method can improve overall manufacturing performance with the same people and machines without technical machine upgrade. As the analytics learning engine uncovers insights about leader behavior in a manufacturing facility, manufacturers can obtain granular data on operator and leader productivity and leverage this data in real time. By preventing losses, maintaining gains, and suggesting improvements, manufacturers can better understand and improve process performance through augmented management and leadership. Other results of the present system and method may include improved engagement of the leader with operators and process, resulting in improved relationships and communication between team members.

Establishing and quantifying clear metrics that contribute to process health as well as data-driven guidance to positively influence those metrics provides a meaningful, actionable, and controllable mode of leadership that can be exercised to guide individual team member performance and stretch for new milestones in process health. Cascade metrics can be provided not only to leaders, but to contributors at all levels, and be vertically aligned and horizontally consistent, and leaders can be encouraged to role model and promote real-time performance dialogues at all levels. Quantifying process health in this way enables alignment of the leadership team around future directions and provides leaders and team members alike with a shared vision of what success looks like and a common understanding of critical performance themes, the nature of change required, and a road map for achieving greater levels of process health.

The process-health focused leadership guidance provided by the present system and method enables leaders to have a combination of deep understanding of the process while simultaneously encouraging hands-on leadership which has consistently been shown to be effective for improving manufacturing process health. The present system and method provides leaders with data such that they can develop a personal understanding of how the process works. Reinforcing lean principles in front line interactions and modeling an environment wherein the process is constantly challenged and open to change and innovation creates a process environment where all members on the team can invest in the process health and own the results. When the leaders asks open and non-judgmental questions like “Why do we do it this way?” and “How does this add value?” team members can be encouraged to engage in process innovation. When leaders regularly make scheduled and unscheduled visits to front line operations and have a “go and see for yourself” problem-solving mentality, they are able to strengthen process understanding and not only learn first-hand what is going on in the organization but are also able to reinforce applicable lean principles and challenge performance to improve overall process health. In this way leaders can deploy a common problem-solving approach across the organization using standard processes, common metrics, using a common language and common data, to build a personal understanding of the process and factors contributing to process health. Leader presence at the site of results creation, such as at the manufacturing floor, also models good process-oriented behavior and promotes real-time performance dialogues at all levels around an aligned set of metrics.

By understanding, being committed to, and modeling process health improvements to other members of the organization, effective leaders can ensure that all operators are aware of their obligation to actively contribute to problem solving and improved results and remind operators both during meetings and on the manufacturing floor of the importance of focus on process health. To provide ongoing process health improvements leader work processes can be continuously observed, quantified, and refined, providing a new way of working for team members at all levels. What once was a leader's gut feeling about a process is now quantifiable at multiple instances in the process, and deconstruction of the particular leader behaviors which positively contribute to process health can be identified and quantified such that the best behavior can be taught and copied and used to create new standards. With the same workforce and time workers can be taught to work smarter, and not necessarily harder, while achieving gains in process health across the board. The present system and method can also help to engage the hearts and minds of members of the entire organization and build an understanding and commitment to striving for an optimized organization and creating a common and inspiring end state and direction.

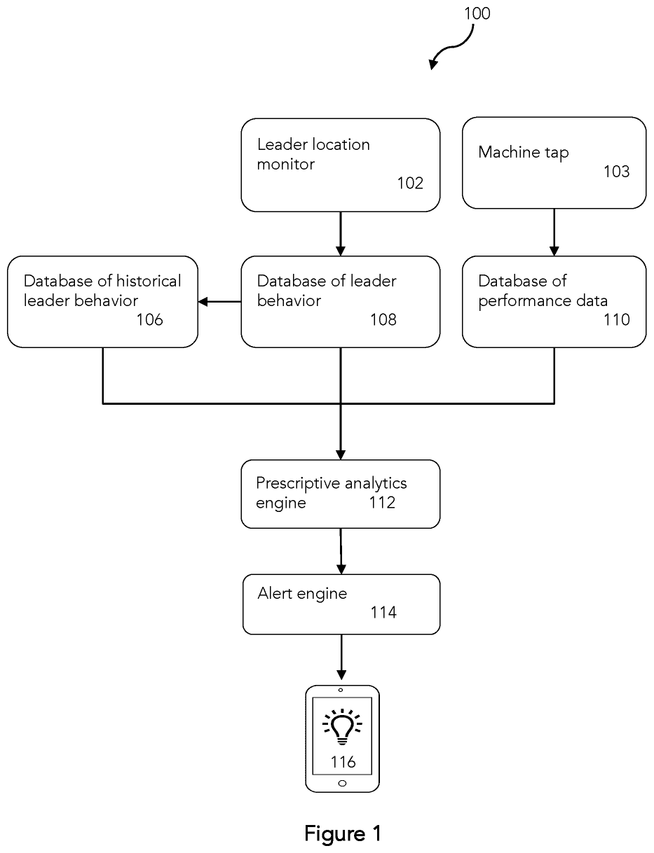

FIG. 1 is a schematic of an augmented management system 100. A leader location monitor 102 tracks leader location and movement in the manufacturing environment. Data on leader location can include where the leader was, for how long, at what time, and who else was in the area or location. An optional leader action monitor tracks and collects data on leader actions concurrently with data collection of the leader location monitor 102. The leader action monitor is electronically enabled for capturing, for example, the details of one or more leader interactions with team members, leader individual actions such as report reading, huddle discussion topics and timing, and communication frequency and content with team members at all levels of the organization. It has been found that a leader's regular direct observation of the production floor where the work is being done can have great benefits in identifying challenges and improving work flow, and data on the travel path and amount of time the leader spends at each stop on the travel path can be collected. On the ground observation of a leader of the manufacturing floor can bring insights into how healthy the manufacturing environment is, and what can potentially be done to make it better. In one example, with careful observation, a leader may notice that the simple act of shifting the location of a refilling receptacle could provide a more ergonomic, safer, and more convenient cadence and movement routine for an operator. The leader actively engaging operators in regular reflection during monitoring walks can also empower operators to consider how to improve their personal behavior can result in minor process improvements which can have an incrementally positive effect. Making regular visits to the production area enables leaders to more fully engage in the daily accountability process and activities on the floor, including monitoring inspection routes and executing pit stops to observe process steps and team members in action. In particular, engaging their sites on a frequent basis demonstrates a leader's commitment to process health-driven organizational growth and transformation, provides leaders with tactile support to the site, and reinforces the cultural expectation that line teams are the true owners of process health and that leaders exist to support that work.

Quantifiable behaviors associated with location in the manufacturing environment include but are not limited to amount of time spent at a particular instrument or machine, amount of time spent with direct reports and/or colleagues, frequency of observation walks, and time spent at a particular location. While many leaders know the value in interacting with their team members, in practice many leaders spend much of their time doing desk work and sometimes find it difficult to be aware of and identify opportunities on the manufacturing floor. Spending more time on the floor enables a leader to be more aware of the operational health of the team and therefore team performance. In particular, optimization of industrial, operational, and organizational health can be correlated with how often leaders visit and speak with operators, do tours of the manufacturing floor, and engage with team members. These behaviors improve leader sensitivity and responsiveness to ongoing operations and operator needs. Tracking the movement and behavior of a leader provides data on how often, where, and how long a leader spends at any given location on the floor, or with other team members. Data on leader behavior includes, generally, timing, location, and duration of leader location and movement. By quantifying the path, duration, and time spent by a leader at each location in the organization, the leader can be directed to visit or spend additional time at locations that may be being neglected or may benefit from additional oversight, and best practices can be developed based on correlations to process health. Tracking leader location and movement behavior on a factory floor can lead to identification of good leader behavior, encourage leader movement or relocation through the manufacturing environment, and provide guidance to leaders on identifying challenges, noticing small details, and ensuring that the leader has a good understanding of the work and work environment of the team members. Leaders who take regular and thorough observational walks through the manufacturing environment are apt to have better relationships with employees and generally have a deeper knowledge of the work environment and thus be able to creatively contribute to the incremental improvements in the operational process.

Further, certain leader actions can have a significant influence on the success of an organization. In-person observation of the manufacturing floor is critical for leaders to understand the manufacturing process, challenges, and operator experience, and information on leader action in addition to location while on and off the floor can be collected and analyzed. The leader's presence on the floor provides opportunities for enforcing expectations with respect to the transformation at every opportunity, especially during face to face interactions. Responding to issues that come up, observing operators, coaching in the moment and identifying future coaching opportunities can help the leader identify local challenges such that frequent, incremental improvements can result over time. By spending more time on the manufacturing floor, leaders are also given more opportunity to praise individuals openly in the organization that are demonstrating behaviors positively contributing to process health. Attentive and present leaders also have more opportunities to find and fix process inefficiencies and model the following of process standards. While on the floor leaders actively participate in and/or lead shift handover meetings and can participate actively in problem solving with team members to improve standards, maintenance, and process health. Tracking leader action during these meetings and team interaction opportunities using the leader action monitor can provide further insights on best practices for topics, duration, style, medium of presentation, and other leader actions that contribute to gains in process health. Leaders can also actively engage team members in their own work environment to develop potential process improvements in one-on-one meetings, during which time data can be collected on the information discussed, medium presented, duration, among other actions, all of which can be quantified.

The combination of leader location behavior data collected by the leader location monitor 102 and optionally also the leader action behavior data collected by a leader action monitor is referred to as leader behavior data. Leader behavior is stored in a database of leader behavior 108, which can be updated in real-time to provide real-time data to the system. Monitoring and quantifying aspects of the leader travel path combined with metrics on leader actions and comparing the overall leader behavior to individual and team productivity and process health can provide actionable data to improve the leader's behavior and ultimately improve operational and process health.

The leader location monitor 102 can comprise a locational sensing device or system, for locating the leader during a shift and collecting data on leader location and movement during the shift. Data on the location of a leader in a manufacturing environment can be collected in a variety of different ways. One method is for the operator to carry a mobile electronic device comprising a gyroscope, accelerometer and magnetometer. Data obtained from this sensor combination can be used to provide periodic dead reckoning measurements as the mobile device travels through a space. By combining of clock and sensor data, an estimate of how far and in what direction the device has moved in the time period can be calculated. Another method of location monitoring is by the operator swiping into kiosks or stationary stations. Transmitting and/or receiving anchor nodes or landmarks in the manufacturing environment can also be used to triangulate the leader location when the leader has a corresponding mobile transmitter or receiver device. A leader mobile device can either be enabled to receive wireless signals from the anchor nodes to locate in the environment, communicate a signal to the anchor nodes in the environment, or both. The mobile device can also have an optional manual input sensor to assist in locating the device on a map at in a location in the manufacturing environment with a known landmark or landmarks, such as but not limited to an RFID scanner, or code scanner such as a QR or barcode scanner. Complementary transmitters and receivers on the anchor nodes and leader mobile device can comprise, for example, NFC (near field communication) transceivers, speakers, ultrasonic speakers, camera, and light detectors. In one example a landmark or anchor node can ping a nearby mobile device and upon proximity of the device to the anchor node, locate the device relative to the anchor node. Further coordination of the mobile device with a geolocation map can be done via RFID and radio signals. In another example, a microphone on the mobile device can to listen to a tone or pulse from a nearby station emitting a tone, or the mobile device itself. Alternatively, the leader mobile device can emit a tone for detection by a nearby anchor node. A similar setup can be done using a signal either transmitted or received by the mobile device to/from an anchor node. In another example, a light sensor on mobile device can pick up data emitted from a light source e.g. pulse pattern from an LED. Localization against the ceiling or ground using visual or emittive landmarks and a corresponding camera or data capture means in the mobile device can also be incorporated into the localization. In an example, in a space that has planted landmarks or visual features such as a floor or ceiling image or map a camera can spatially locate the device by triangulation relative to the stationary visual features. Other sensors can also be used to provide additional data at various states, such as proximity sensors or light sensors to determine, for example, the location of the mobile device on the moving person, such as exposed or in a pocket. Yet another way leader location can be tracked is by calculating travel path and duration of an individual in an environment is described in Applicant's U.S. provisional patent application 62/503,648, entitled “LOCAL LOCATION MAPPING SYSTEM AND METHOD”, filed on May 9, 2017, incorporated herein by reference. In yet another method of collecting leader location data, one or more locational beacons or anchor nodes may be used to provide an absolute spatial location of a leader mobile device, and can partially or completely constrain one or more dimensions in one, some or all degrees of freedom. Stationary beacons or anchor nodes can be emitting and/or receiving devices, and have complimentary technology on a mobile device on the person being localized in the environment. An optional altimeter and/or barometer can provide altitude measurements of the mobile device relative to the earth surface. In a case of a facility with multiple floors having a similar layout, an altimeter can provide vertical location information to differentiate the vertical location of the device. In an environment with one or more anchor nodes, the anchor node emitting a radial signal on the ceiling of a lower floor and/or an altimeter reading can assist in differentiating location on lower or upper floors.

The location including timing and duration of movement of team members other than the leader can also be collected in a similar manner and added to the database of historical behavior 106 to provide additional information on who attended huddles or team meetings, when they arrived and left the meeting, and the movement of individual team members throughout a shift. Identifying the leader actions and behavior that has the greatest effect on process health, either positively or negatively, can be leveraged in an organization to improve process health at all levels. Leader behavior is the aggregate of leader location and leader action for a given period of time, and, once collected, is stored in a database of leader behavior 108. Leader behavior data is also stored longer term in a database of historical leader behavior 106 for historical and pattern analysis. The database of leader behavior and the database of historical leader behavior can be one in the same, or can be separate databases. Data is stored such that it can be called upon by the prescriptive analytics engine 112. Leader behavior data, including leader location data, is then correlated to individual operator and team productivity to provide best practices to leaders. Comparison of leader behavior with historical and real-time productivity data can optimize leader work flow.

A machine tap 103 collects machine data and also optionally context data either automatically from a machine data stream or sensor, or manually when an operator enters data, optionally by a tag by time and state, at a machine user interface to indicate the nature or state of the machine or process at a given time. The machine tap obtains and/or introduces machine data into the system. The machine tap can be connected directly to a machine, or can obtain machine data through an intermediary device, network, server, enterprise resource planning software, PLC, or data stream. Machine data can include but is not limited to sensor data collected on motion, light, sound, temperature, or other data related to machine functionality. Context data can be obtained from the machine tap, or can obtained from a connected computer, intermediary device, enterprise resource system, network, server, database, or combination thereof. Context data comprises additional context about the machine, operator, schedule, time and date, provenance of primary materials, or other data regarding the machine or operation thereof. The machine tap may also be configured to do edge processing such that analysis can be done close to the point of data collection or display to reduce bandwidth, data storage requirements, or computational load on the server. A machine user interface can also collect data and performance analysis on the data stream and perform simple data processing or transformation such as translating an incoming data stream into a compressed data representation of the performance data.

A database of performance data 110 comprises historical and real-time performance data pertaining to the operation and performance of machines, operators, teams and the organization or part thereof at or during a particular time. The database of performance data can be integrated with the leader behavior database(s) or can be separate. The performance data can be collected from a machine tap 103, and can also include context data. In the prescriptive analytics engine 112, correlations are calculated between leader behavior, provided by the database of leader behavior 108 and database of historical behavior 106, and performance data, provided by the database of performance data 110, to identify patterns of leader behavior and individual or team outcome. Collection of metrics on leader work behavior based on location metrics and time allocation can be combined with machine learning and/or artificial intelligence in the prescriptive analytics engine 112. Correlations in the prescriptive analytics engine 112 can be done based on a comparison of individual values or metrics, multiple values or metrics, or the system as a whole. In an individual values correlation, two values can be compared, one value of leader behavior and the other of performance data, to see if there is a correlation between the two. Leader behavior values can include but are not limited to: amount of time spent on the manufacturing floor during a shift; time of huddle during shift; duration of huddle; amount of time spent on one-on-one mentoring; amount of time in huddle focused on a particular element, such as safety or performance; and amount of time spent reading. Performance data values can include but are not limited to: machine downtime; output by operator; team safety values (number of, frequency of, or severity of safety incident); individual or team morale; changeover time; product quality; OEE; machine or operation performance; employee absence rate; and process output. As an alternative, system correlations can be calculated using multiple metrics, where at least one metric is a behavior metric and at least one metric is a performance metric. In both individual values correlations and system correlations, similarity measures can determine correlative rules and be used to generate a model of leader behavior correlated with organizational performance. Historical patterns of leader behavior can thus be found by the prescriptive analytics engine 114 that correlate to performance results which would otherwise be difficult to ascertain without correlation algorithms running in the prescriptive analytics engine. This model can also be employed for real-time monitoring of leader behavior to suggest leader action in real-time and then fed back into a real-time leader workflow list to improve leader standard work flow.

In one specific example, one or more performance metrics may be probed while the system was at a particular system state, to understand the effect of leader behavior before, during, and after the particular state. For the system state, a leader profile (location, time spent, etc) can be generated, which can provide leadup information, such as trends in leader behavior that may have contributed to the particular system state, as well as responsive leader behavior that may have contributed to mitigation of the particular system state. The combination of proactive and reactive leader behavior can be further modeled to provide guidance to the leader to help avoid negative system states and encourage positive system states.

The prescriptive analytics engine 112 processes the data and can send a real-time alert from alert engine 114 via a remote device 116, or alternatively queue the alert for later review if the alert is not urgent. Reactive alerts or real-time alerts can be provided by the alert engine 114 advising on an immediate action recommended to address the operating performance of a machine or operator or to mitigate a predicted effect on process health as projected by the prescriptive analytics engine 112. The alert engine provides an alert to the leader to change leader location behavior which has been predicted by the prescriptive analytics engine to have a desired effect on process health. For example, if real-time process data recognizes a prolonged machine state of ‘idle’ and the leader location monitor indicates that the leader is at another location and may not be aware of the machine idle state, a time sensitive or urgent alert can be triggered to direct the leader to relocate to the idle machine. The system can then recognize that the leader arrived at location, records the time spent attending to the task at the location, optionally records leader action while at the location, and can record the delay in response time between the alert and the time to arrival at the alert location. Notification and alert fatigue can be problematic because the person receiving the alert is either overburdened, or the alert is ignored because the person overlooks the urgency of the alert. The system can learn when alerts are effective by determining when the alert is acted on, which can be user specific. In one example, it may be found that a particular user or group of users has an ideal maximum number of alerts per day that they will effectively respond to, and the system can be tailored to limit the number of alerts to the ideal number. A balance between reactivity to alerts and proactive activity can be thus found to augment leader behavior. Correlation of the leader schedule with the alert system can also send out alerts during a time when the leader is more able to respond, leaving the leader free to complete essential tasks without interruption. An alert budget, or a soft maximum number of alerts that should be sent to a user in a particular time range, can be designed or learned in the system, or can be set by a user of the system. In the case where an urgent situation occurs, the alert budget can also be exceeded to allow for responding to urgent situations. In one model, the alert system can be set to limit alerts to those above an available threshold opportunity and those with urgent requirements, with daily threshold limits varying depending on the running state of the facility.

The alert data stream itself can also be an input to the alert engine 114, meaning that alerts can be a further trigger to other alert conditions. In particular, observation of the alert stream, such as how often certain alerts have occurred in a period of time, can also trigger further alerts by the alert engine 114. By analyzing the process data other longer term trends may emerge, such as an operator slowdown on the hump day (middle day of the shift week), increased operator productivity when working on a shift with another particular operator or leader, or leader effectiveness with a particular shift. In combination with leader location data, further understanding of how often and to what extent leaders are observing and communicating with operators can be correlated to process data to provide best practices for leaders. In an example, real-time operator data may show that a particular machine was having a highly fluctuating machine speed, wherein it had previously been found that erratic machine speed in a given period of time has a tendency to result in reduced productivity or is indicative of a machine problem or imminent failure. The leader can be queued to walk over to the operator and engage in a probing conversation to try to identify, with the assistance of the operator, the reason for the fluctuating machine speed to address the issue before an escalation event such as a machine failure.

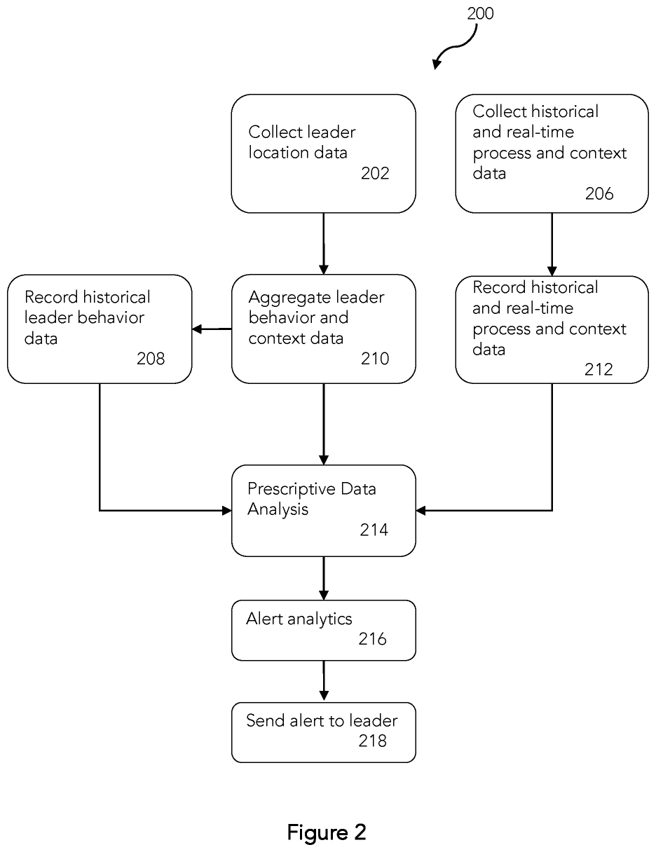

FIG. 2 is a flowchart depicting data collection and flow in an augmented management system 200. Real-time leader location data is collected 202 optionally along with real-time leader action data. Historical and real-time context and process data is also collected 206. Collected leader location data 202 and real-time leader action data are aggregated as leader behavior 210 during a given time period or at a specific moment. Performance data can include operator performance data such as, but not limited to, human resources assessments such as late rates, absence rates, break times, overtime, and operator safety, as well as machine data. Performance data and machine data can be obtained from one or more sensors taking one or more sensor readings over time and be collected as raw performance data by the machine tap. Some sensors useful in the collection of performance data are described in the Applicant's U.S. Pat. No. 9,816,900 entitled “METHOD OF MEASURING EQUIPMENT PERFORMANCE AND DEVICE THEREFOR”, incorporated herein by reference. Process data can also include context data which provides context for the machine performance. Context data can include but is not limited to which operators are on shift, which machine or machines they are working on, time of day, and the historical data associated therewith, such as operator day of the week, leader on duty. Context data be obtained from the operator of the machine at a machine user interface, which can be used to set up and report SKU, task or operational information, and call for assistance. The context data can also include, for example, identification of the part being manufactured, step of manufacturing, identification of the operator at the machine, batch information, information about the task or operation being done by the machine (SKU task), information on the primary materials being processed by the machine, work order identification, or machine task in progress, raw performance data, or tags which describe the machine state at a particular time.

The aggregate of leader behavior is collected and stored as historical leader behavior data 208, and the real-time and historical leader behavior data is transmitted periodically along with historical and real-time process data 212 such that a prescriptive data analysis can analyze the historical and real-time leader behavior data and historical and real-time process data and performs prescriptive data analysis 214. The system can identify points of greatest opportunity for gain by, in one example, looking at mean and outliers to mean, with low performance outliers flagged for correction and high performance outliers for potential investigation to see what they are doing well. Another more general method could use a forward simulation model for performance and behavior to look at variation of outcomes. Metrics that have been found to have a correlation with performance will be weighted higher, and metrics that are not found to correlate with improved process health can be given a lower weight.

Data can be transmitted through the system optionally via a server, which can be a local server, cloud-based server, or a server at any other location. Data can be transmitted periodically as a batch appropriate for the machine, such as, for example, every fraction of a second, every second, or once every few seconds or minutes, which can be set automatically or manually based on the machine or process. Alternatively, data can be transmitted as a stream with new data being transmitted immediately, or a combination of batch and stream depending on the acquired data. Changes in machine state or machine operating state can also trigger a performance data update to be sent to the server. Transmission can be hardwired or wireless, such as, for example, by wifi or Bluetooth.

Alert analytics 216 is performed in an alert engine, where an algorithm translates data received subsequent to prescriptive data analysis 214 from the prescriptive analytics engine and compares the data against a set of trigger definitions. Each trigger definition comprises a set of conditions which, if met, result in an alert. Alert analytics 216 can monitor and process data in the data stream from the prescriptive analytics analysis to test for each trigger definition. Alternatively, data can be also be sent to the alert engine directly from the leader location monitor and/or leader action monitor to compare the data against real-time triggers to provide timely alerts. Each trigger definition can include but is not limited to: threshold met; threshold average over time; idle time; probability of occurrence of an event; impact of the event, potential or potential losses; and combinations thereof. A trigger definition can also be based on a combination of received data, such as if more than a particular number of machines in a network have been idle for more than a particular period of time, and if other alerts have been raised. If the particular trigger definition is satisfied and the alert is time-sensitive, an alert is sent to the leader 218 via a remote device on an alert data stream. For each alert, a trigger definition determines when an alert is created, raised, and sent to the leader 218, as well as the prescribed action that a leader can take to mitigate the alert or alert conditions. An alert generated by alert analytics 216 can comprise the content and/or conditions associated with the alert, and can also include a recipient and a medium of communication, priority of the alert, all of which can vary according to the urgency of the alert. The priority or urgency of the alert can be based on, for example, expected or potential financial loss, improvement initiatives of the company, proximity of responder, load on the potential responder, etc. Trigger definitions can also include frequency and duration of alerts, and further indicators of process health and/or organization health can be monitored and brought to the attention of operators and managers for process improvement. Alert priority can also be based on the calculated or known bottleneck in the production process such that alerts which address the bottleneck receive more immediate attention.

An alert can be provided to the leader for immediate action, or for adding to a script for later communication to an individual or group of individuals, including to the leader themselves. Alerts can be generated for immediate action (time-sensitive) or for later communication (not time-sensitive). Alerts for immediate action may include instructions to visit a particular machine or area of the manufacturing floor that is experiencing issues having an effect or predicted to have an effect on process health, or a particular safety issue tagged as part of the process data that requires immediate attention. Process data such as a sudden increase or long duration of tagging frequency for machine operation also provide an opportunity to alert the leader to go over to the machine to investigate and can be brought to the leader's attention in a time-sensitive alert. Trends and data that is not time-sensitive can be provided to leaders as non-urgent alerts, or as electronic communications in a variety of formats, and may include data such as variability trends in machine operation, operator operation, frequency and duration of breaks taken by an operator, and other matters that can be addressed with individual operators or team groups. Specific types of operator alerts can also be set to trigger for immediate response if the leader identified a particular problem area. In one example, if an operator has been put on notice for excessive taking of breaks without putting the leader on advisement, leader can request an immediate alert flag when the operator returns to machine after a break of longer than accepted duration or of greater than particular frequency so that leader can discuss with operator immediately after the operator behavior has been noticed.

Diagnosing the organization using operational and business metrics can highlight the opportunities and focus areas for the design of new work systems and processes. Analysis of performance data in combination with leader behavior data can uncover the strengths and opportunities of the business under examination. A score or process health can be assigned based on the aggregate of performance data to understand the current business situation and provide improvement direction and objectives to the leader. Based on collected performance and behavior data, a formalized tactical implementation plan can be developed and implemented on the basis of the performance data as the basis for systemic implementation for process health improvement. The tactical implementation plan can provide details of opportunities, data, and specific actions, owners and timelines for process health improvement, which each recommended course of action linked to delivering a target result. Implementation of the tactical implementation plan requires the full engagement of the leader, as the leader will be the role model and change agent for team members to encourage the commitment to process health improvement. Leaders can further encourage development of new standards based on team best practices once identified, and coach adoption of best practices across the organization. Further, sustainability of the transformation is reliant on disciplined execution and unwavering leadership behaviors. Further, leader focus on process health can be empowering to workers because it positions them as the authors of process health improvements for the organization. In particular, reduction of workplace injury, improvement in working conditions, and guided recommendations for worker performance can improve productivity and quality at all levels of the organization.

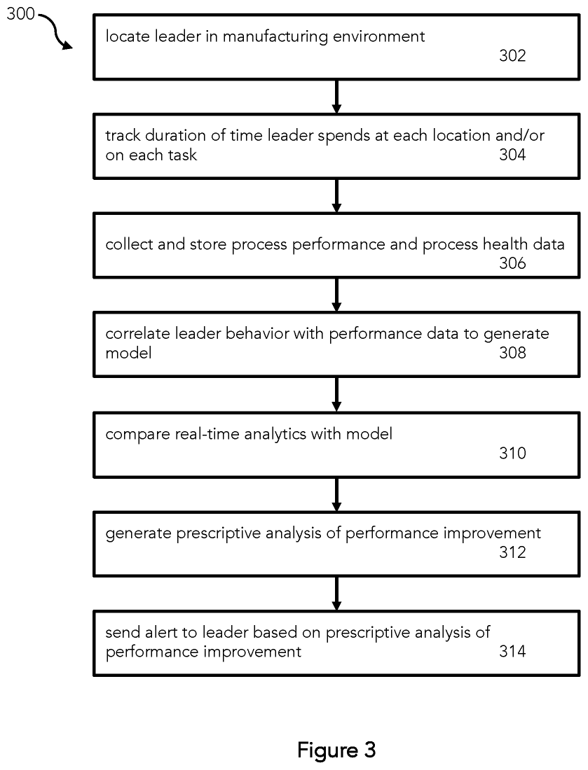

FIG. 3 is a flowchart depicting a method of generating a leader alert in an augmented management system 300. The system first locates the leader in manufacturing environment 302. Leader location in the environment can be collected periodically, such as once per fraction of a second, once per second, or longer duration. The duration of time that the leader spends at each location and/or on each task is also recorded 304, as is the speed of travel and path of travel. Concurrently, performance and process health data information for each machine, team, individual, and process is collected and stored 306. Using the collected data, leader behavior is correlated with performance data 308. Patterns and correlations of leader behavior can be modelled, and leader behavior data is compared with process health and performance data to model short and long term predictions of how leader behavior contributes to process health. The generated model can then be compared with real-time analytics 310. The real-time analytics provides a real-time analysis of process health based on current leader behavior and generates a prescriptive analysis for process health improvement 312. An alert can then be sent to the leader based on the prescriptive analysis of process health improvement 314, with the expectation that the prescriptive analysis will result in an improvement to process health, or mitigation of potential loss. Alerts can optionally be presented as tasks on a task list, and the task list can take the form of a list, independent or linked message, or location on a map to which the leader is directed to visit. Tasks based on each alert can be time-specific, i.e. show up at timed intervals on a dashboard, map, or task list, and provide the alerts to the leader based on a time-sensitive ranking to ensure that tasks are being done in the order for which their intervention will have the greatest effect. The prescriptive analytics engine can also add regular non-urgent tasks to the task list based on prescribed actions found by the model to improve overall organizational performance, including covering a particular location on a gemba walk, prompting a reflection meeting with an operator, or spending additional time on an aspect of safety in a huddle. Tasks can also be prioritized or re-prioritized to prompt leaders to address more pressing emergent issues. Alerts actions can also take priority over other tasks, providing an “Action Required.” Alerts with high priority can be determined based on safety, or real or anticipated efficiency or productivity loss. For example, a routine walk may be scheduled, however the analytics may show that a particular machine or operator is experiencing a slowdown. Redirecting the leader to ensure that the machine or operator experiencing a slowdown is provided with sufficient resources to get the machine running optimally can be prioritized as such preventive action can have a great effect on overall productivity and the routine walk can be performed at a time when the floor is operating well and the leader can be most attentive to the routine running of the operation. Tasks provided to the leader can also be linked to the data pattern as analyzed to provide prescriptive analytics engine to justify why a particular task is worthwhile or being recommended. In this way, the system can train the leader to understand and embrace how to be a better leader. In particular, an alert can provide guidance such as: “The more often you visit an area the better the performance of that area. You haven't visited area A3 in a while . . . go check it out!” This helps leaders understand how their behavior impacts organizational health.

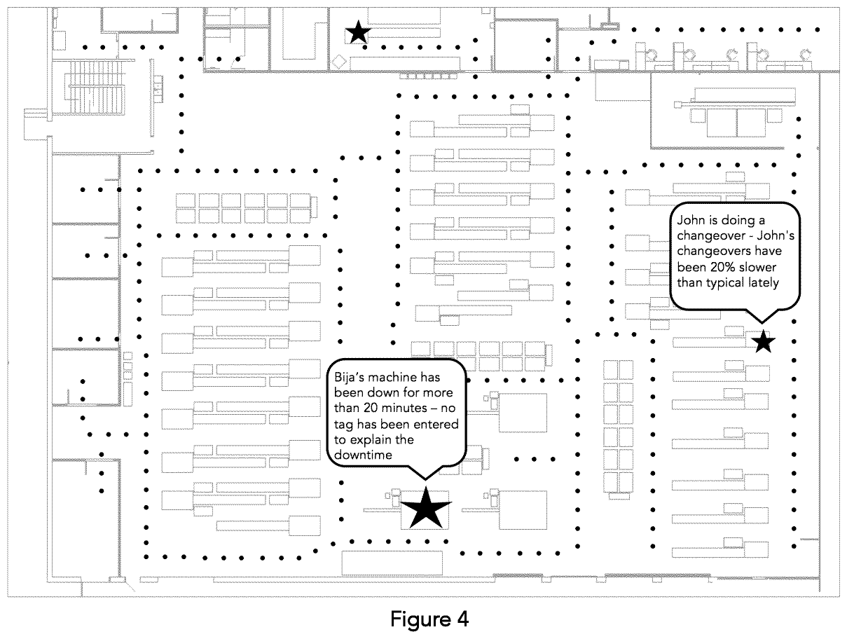

FIG. 4 is a floor plan view of a manufacturing floor with an overlaid leader location and movement pattern. The leader location pattern is shown as a travel path through the accessible space in the manufacturing environment. The accessible space available for travel is any space in the manufacturing environment coincident with any part of the travel path of any worker and can be mapped using leader and other team member location tracking through the environment. Information on accessible space may be extended by incorporating additional data, for example location and/or orientation data provided manufacturing components or assets. The combined data on asset location and accessible space can provide a dynamic map of the indoor environment. Recommendations or guidance for leader movement, relocation, or action is based on prescriptive analytics which provides opportunities for leaders to address opportunities based on potential gains of process health. To illustrate the leader's recommended location behavior, icons on the map can change in appearance, such as size or color, and may be removed once visited. Leaders can also be provided with additional information for each recommended visit location, action, or behavior, such as trigger details that can be responded to with a leader action. Additional information, such as the time spent by a leader at a specific grid point, number of visits to a grid point, grid point criticality, or other weight information can be indicated through the icons. Urgent locations to be visited can have additional indicators such as animations or additional text to provide urgency indicators or direction to the leader as to the action required at a particular location. As leaders approach the assigned location the system can record that the location has been visited. The time and duration of the visit can also be recorded. To illustrate the manufacturing environment, each worker-accessible space is represented by an icon on the map of the manufacturing environment, with one icon per worker-accessible grid point. Leader location tracking for a leader on the map can indicate that a leader is not regularly walking through a particular section of the manufacturing floor. The leader can thus be queued to walk to a location that has not received sufficient attention to ensure that things are running smoothly.

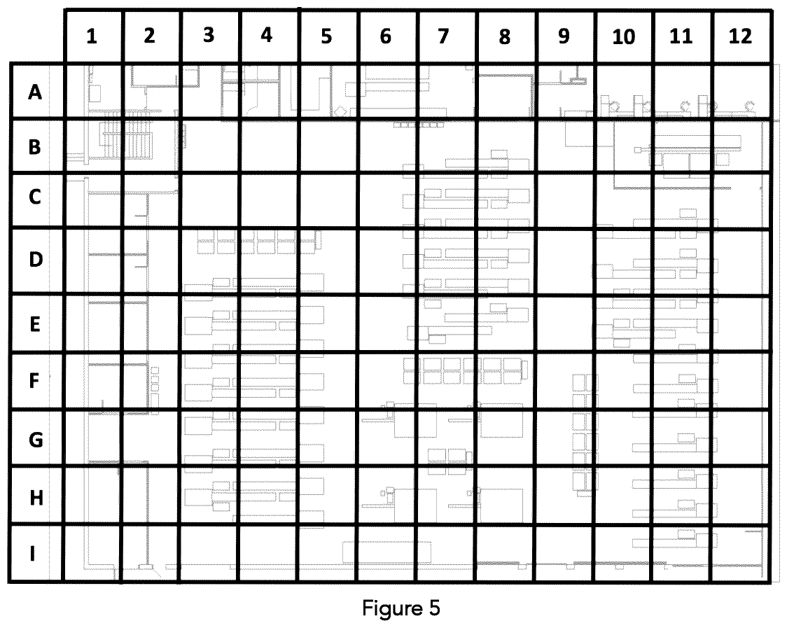

FIG. 5 is a floor plan view of a manufacturing floor with an overlaid grid. In one example of travel path mapping, the accessible space in the manufacturing environment can be mapped onto a grid with a coarseness dictated by the distance required from the leader for the leader to be considered to have effectively interacted with a space or location in the environment. Any grid point that contains a worker-accessible space is a target for a leader to visit and can be recorded as ‘visited’ by the leader if the leader comes within a certain distance of the grid point. A leader is deemed to have visited a grid point when the leader location is contained by that portion of the grid. Alternatively or in addition, accessible space and/or leader targets could be manually assigned, such as individual operator workstations.

Incentives can also be provided to leaders to encourage behavior known to have a positive effect on efficiency, productivity, quality, safety, or other goals on the manufacturing floor. Some incentives may be based on rapidity of the leader to respond to alerts, reduction in the number of alerts based on historical data, or formalized quantifiable follow-up on alerts with team members to improve process health. Tracking leader responsiveness to an alert can be based on, for example, the amount of time it takes the leader to arrive at an alert location, follow-up tracking of leader educating team members about the alert during a later huddle or one-on-one meeting, or changing location or action behavior to reduce the circumstances contributing to the alert such as, for example, visiting a frequent alert site more often or digging deeper into particular machine or operator performance data. A score card can also be provided to leaders to provide a score of how quickly the leader responds to tasks, with greater score available when tasks have a greater weight based on effect on process health. In one example, a leader can be provided with a task to be done and a timer or countdown to indicate the urgency of the task. If the leader performs the task in a short amount of time a gain performance of opportunity can be realized to the organization and the leader can improve their personal score. A leader report can indicate the leader response time to address task presented, the resolution time for each task, and provide further feedback about how to improve a leader's individual score. One potential scoring method is to have a goal of minimum downtime minutes, and the leader goal can be to pickup extra minutes of productivity (reduce downtime minutes) by acting on tasks that decrease the number of downtime minutes. A score of downtime minutes for the leader can be provided for a shift or time period. Another scoring method can be based on the predicted loss or downtime and offset of loss that can potentially be gained as a result of the leader behavior. A gain of productivity or reduction in downtime minutes can be scored as a loss mitigation gain for the leader.

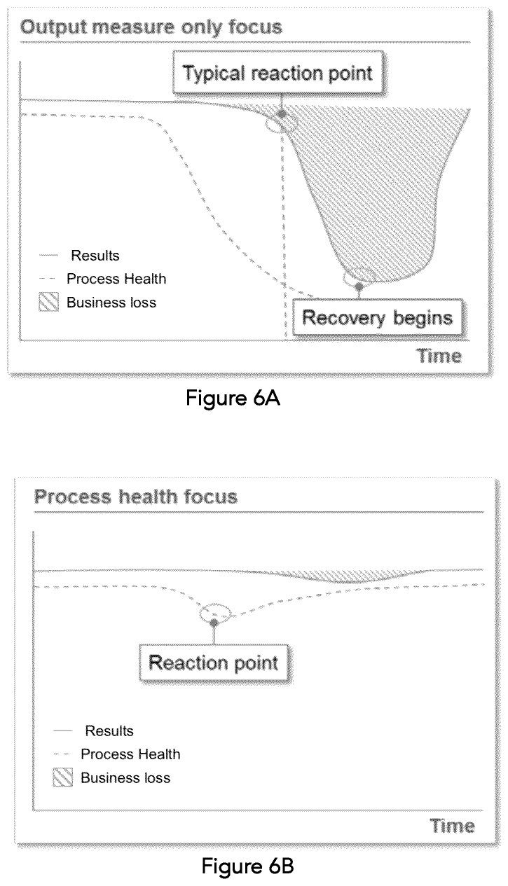

A leader output only focus mindset results often results in the output graph shown in FIG. 6A, where process health begins to fail but is not observed until the reaction point when the results of the process begin to slip and are observed. At this point all efforts refocus on regaining the results but the in progress downward slip in process health invariably accompanies a business loss until the process health can be fixed and results recovery takes place. This reactionary focus is in contrast to a process health focus, shown in FIG. 6B, where the focus of the leader is on process data, and any reduction in process health is immediately observable and can be acted upon before the results are affected. As shown in FIG. 6B, a process health focus results in an earlier reaction and recovery point, less effect on the process results, and a reduced business loss. When leaders are focused on process health, decisions are made based on predetermined principles and decision making becomes much more effective and decisive. Leaders in this mode depend on standardization at all levels of the organization and less time is spent reacting to problems already contributing to operational loss. Periodic site visits where the leader shows up regularly to the manufacturing floor to model standards of excellence and diligence to other team members also reinforces process health and combats short-term focused, reactionary behaviors. In particular, when short term targets dominate the thinking and decision processes at senior levels of the organization, less effort is spent on standardization and process optimization. This can be characterized by continuous changes in strategy which may feel chaotic and unfocused. Focus on the near term means that process metrics are rarely if ever used to make decisions and building capability in the organization becomes a secondary priority compared to today's results.

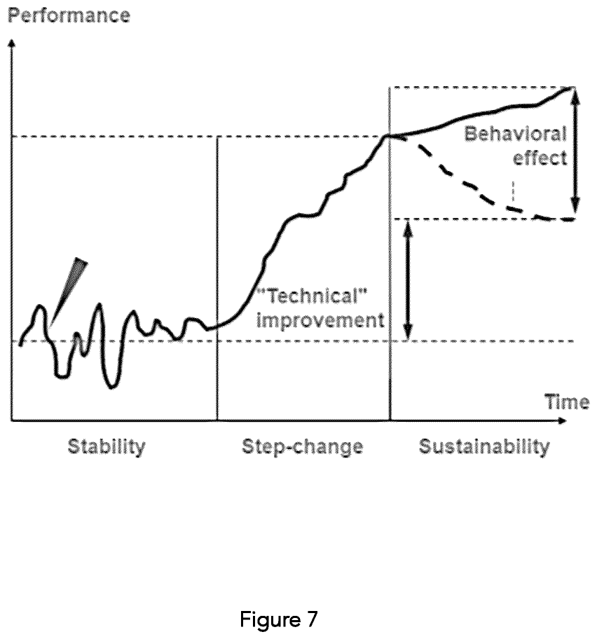

FIG. 7 is a graph of performance over time as a result of a process improvement. Opportunities for technical and engineering improvement can come to light within the system that can result in stepped change in loss mitigation or process health improvement. In implementation of the technical improvement an initial improvement is often observed, however many transformation efforts fail to sustain results over time, with many of these transformations failing for behavioral reasons. Success is understood as occurring when the improvement program achieves its objectives, or when the process improvement results in the desired improvement outcome. Failure of the process improvement to achieve the desired results can be the result of, for example, employee resistance, senior management behavior not supporting the change, insufficient resources and/or budget, and other obstacles. Monitoring and encouraging the behavior change can help to shepherd the technical improvement through to become part of the process standard.

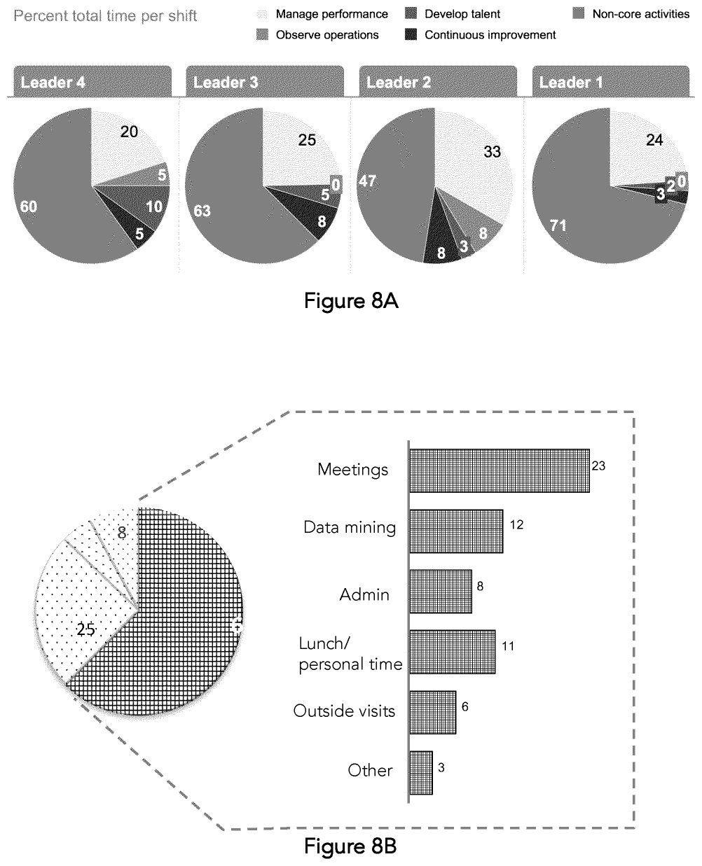

FIG. 8A is a set of pie charts for four leaders showing amount of time spent on each of a set of leader activities. In an analysis of leader activity over time, the system shows that leaders are not spending enough time on core activities, with some leaders spending on average less than 50% of their time on “core” activities. These core activities can include managing performance, developing talent, observing operations, and continuous process improvement. Non-core activities include administrative work, training, and equipment repair, and have a much lower impact on process health improvements than core activities.

FIG. 8B is a pie chart breakdown of non-core activities of Leader 3 from FIG. 8A. Distribution of leader non-core activities is divided up into meetings, data mining, administration, lunch or personal time, outside visits, and other. This second level analysis suggests that leaders are spending >30% of their time in non-core meeting and manipulating data. In this case, the system may recommend the leader to spend more time on core activities, and specifically those core activities determined to be most beneficial for process health.

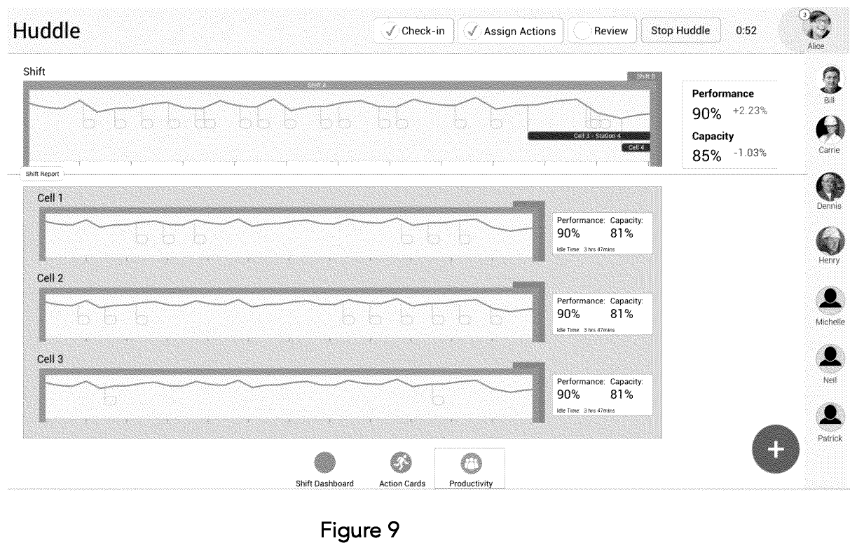

Huddles or team reflections meetings are an occasion where team members get together to be presented with operational and safety information and are standard practice in leader standard work. FIG. 9 is an example board or screen for a huddle. Huddles are generally used to ensure that each person in the team knows what they are to do that day and directs the attention of team members to important issues and potential process improvements. Process and work flow are components of the huddle, with agenda items to be discussed by the leader and team as part of the work flow. Agenda items within the huddle workflow can be tracked, for example, the time during the huddle that the agenda item was discussed, and duration of time spent discussing each agenda item. Agenda items can also be tailored to the specific requirements of the team. In the figure, team members listed on the right are participating in the huddle and can be assigned tasks during the huddle. Assigned tasks can also be later tracked for completion. An effective leader is capable of creating a clear and aligned purpose and direction for the organization and its team members, inspiring and communicating goals, stretching the aspirations and pace for performance and health of the process and its team members, and reinforce the purpose and direction with members of the broader organization. In particular, leadership behaviors that support improved manufacturing line performance management can include but are not limited to being present and taking a leadership role at shift handovers and similar reviews, reviewing daily production reports from production leaders and challenging the results, coaching other leaders and reviewing their meeting management and ability to engage the participants during and after the meeting, running meetings as they want your subordinates to run theirs, being a role model of excellent organizational behavior, and following up on the outcomes of daily operations meetings. Credit can also be given to team members privately as well as publicly when a result or metric is showing improvement, and inquiry can proceed if there has been an opposite trend. Leaders can also be made aware of situations where development of team member skills would be beneficial to induce positive change. Change can be reinforced by leaders to team members with formal structures and processes to ensure there is a clear link between the process health of the organization and individual production performance. This can be accomplished by, for example, visualizing key performance indicators during group and private meetings, and ensure that key metrics and targets are regularly updated and relevant for the individual team members.

Deployment of visualization of process health metrics can be undertaken at the front line with manufacturing floor team members both one-on-one and in huddles to educate and motivate team members to strive for improved process performance and process health. One example analog board for a huddle is shown in FIG. 9. During huddles a variety of topics can be addressed and planned to organize, educate, and motivate team members. Some examples of huddle topics include but are not limited to assigning operator to a machine and task for the duration of the shift or part thereof, advising team members on order status and the details order fulfillment, project prioritization, and projected completion time of task. Huddles can also be used to teach a technique, provide course correction, introduce a performance initiative, or remind staff of safety. Team huddles can also be used to inform team members of team priorities and can provide an opportunity for leaders to teach and model problem-solving and encourage team members to engage in the optimization of their own work. The leader can use the huddle to report on recent events, issues that have delayed project, new issues such as new devices installed, news in the company, or available training sessions coming up. Quality issues can also be discussed and the leader can provide an opportunity for huddle attendees to raise issues such as process challenges and solicit leader assistance or other operator feedback for individual improvement. In an example of a toothbrush manufacturer, if a particular batch of bristles is found to be difficult to secure, options of a different step or process variation can be discusses at the huddle to improve process and therefore product quality. Attendees can include machine operators, line workers, technical leads, maintenance technicians, supervisors, higher leadership, production engineers, and anyone else involved in the daily process operations of the organization, and attendees can be encouraged to participate and/or lead parts of the huddle according to their expertise.

Huddles can be scheduled at any time during a shift. Popular huddle times are at the beginning and/or end of a shift, however mid-shift huddles can also be used when there is a change in team activity. In some automated processes, machine operations can continue to run while the operator is in huddle. Some huddle topics include but are not limited to: maintenance tasks, a spike of failure of a particular type on a particular machine, a deteriorating condition that requires attention to avoid escalation, scheduling of jobs, team productivity plan, productivity targets, updates in machine performance, report fixes, scheduled maintenance plans, and reporting of machines out of order. Assignment of shift roles and responsibilities as well as discreet tasks such as dealing with a particular machine can be done during a team huddle. Other than scheduling, the topics most commonly discussed in huddles are safety, quality, and performance. Reporting of observed trends during huddles or privately during an individual reflection meeting with a leader can encourage operators and team members to modify behavior to meet organization priorities and targets. Leader behavior data during the huddle can be collected to correlate time spent or data presented during a huddle and the effect of such reporting on organization health. In this way organizations can learn what information is most helpful for team members to see and discuss to make gains in a particular area of priority to the organization.

In an example of a safety issue that may be discussed in a team huddle, a particular safety improvement can be provided to the leader for discussion with the team, and later data can be analyzed to see if the more in-depth or pointed safety discussion had any effect on rates of injury. Reporting safety issues can provide an opportunity to remind operators that use of a particular requires certification and/or proper safety precautions. Collecting data on what was discussed during huddles and when can also contribute to and assist with reporting and progress tracking. In an example of a performance issue that may be discussed in a team huddle, performance data can be shown to team members to see if providing such information was useful and actionable to operators. In one instance, reviewing trends on machine slow-down or downtime and providing tips on how to limit machine slow-down or downtime may contribute to overall productivity. Addressing both safety and performance issues may benefit from moving the huddle to a particular machine so that the leader, an experienced operator, or a technician can provide a hands-on or on-site demonstration of improved process or safety practice. This movement in the huddle can further be tracked to determine whether live demonstration in a particular instance can lead to improvements in operational health.

In an automated offering to a leader, a checklist menu of items can be provided to be discussed in a huddle or one-on-one discussion, and the presentation can be projected from an electronic device or displayed on a screen. In an automated presentation, data can further be collected on how much time is spent discussing each of safety, quality, and performance, or sub-topics thereof. Data can be collected on when and how often are huddles happening, how long are they taking, who is present, the huddle location, medium of presentation (e.g. screen, bulletin board, whiteboard, oral only) and how much time is spent on each aspect of team operation. In particular, data concerning the specific topics discussed at a huddle can be collected using a display screen with timing collected on how much time was spent on each screen. If the huddle screen has options for discussion, such as particular aspects of the process, safety or performance, operators can drill down and data can be collected on how much time the leader spent on each sub-screen in the huddle presentation. Alternatively, in a huddle next to an analog display such as a chalkboard, bulletin board or white board, a camera can be used to track the attention of the leader at any given location at the huddle board to determine how much time was spent discussing each of safety, quality, and performance. During huddles, recording the amount of time can be correlated to performance in the specific area. In an example, spending more time on particular aspects of safety and ensuring that workplace safety is top of mind for operators may have a positive effect on improving safety which is measurable in later reports. A camera can also be optionally used to track the huddle for additional feedback into the system, such as, for example, time spent on each item in the agenda. Data can also be collected about who is near the huddle, when each person arrived and departed, how long was the huddle, when did it start and end, at what point in the shift was the huddle relative to start of shift, optionally using additional location monitors for one or more members of the team other than just the leader. Data can also be collected on the amount of time spent on each topic, how much time the leader spent drilling deeper into the issue, such as showing an image or video of a process workaround. Feature vectors can also be used to denote and record the huddle data. Some features that may be included in a feature vector are but are not limited to: duration; start time; end time; attendee identification; location; presentation medium used; time spent discussing safety; time spent discussing performance; time spent discussing quality; and number of issues discussed. In response to data analytics on the huddle in combination with historical and real time performance data, the prescriptive analytics engine can also provide a tempo or pacing for the ideal amount of time, timing, material to be presented, and location for the leader to be spending on each element in the huddle.

Individual reflection meetings between the leader and individual team members can be used in much the same was as a huddle, focusing on optimization of the performance of an individual. Similar techniques can be used in a private one-on-one, including improvements particular to a specific operator that will improve process performance for that operator. e.g. break times, filling frequency, slowdowns or variability in machine running speed to get more consistent. Data can be shown to particular operators, some of which may respond positively, others negatively or not at all. Some leaders find that individual reflection meetings can be uncomfortable and stressful for operators, however since team performance is dependent on the performance of each individual on the team, information gained from individual reflection meetings to improve individual performance can have a noticeable impact on overall institutional performance. To assist leaders in both individual meetings and huddles, scripts or discussion points can be provided to direct the leader to probe into potential process improvements with the team member. In an example, if the prescriptive analytics engine suggests that filling operation consistency will improve process performance, the operator or team of operators can be provided with suggested improvements to be made to improve filling procedures, and these can be discussed during a huddle. Performance results can then be measured based on the discussion of improved filling procedures for the team for that shift that receives the guidance during a huddle.

Particular scripts can also be provided to leaders to model and train best practices for communication with operators to encourage collaborative problem-solving. Dynamic phrasing examples can be suggested to leaders to open cooperative communication with operators about machine and process optimization, which can be provided to train leaders on best practices to efficiently obtain process information while respectfully engaging operators in the manufacturing optimization process. In one implementation, a full script can be used to provide the leader with guidance as to how to conduct a huddle or reflection meeting. Giving leaders specific things to talk about with specific people can help leaders to coach critical thinking, providing positive reinforcement, and develop a positive relationship between operators and the leader. Leaders can be queued to ask specific probing questions that have been shown to assist with engaging operators, such as, for example: Who do you speak to when something goes wrong? What challenges are you experiencing? What are you doing now? An agenda can also be provided indicating topics for discussion in a meeting, what questions to ask, and how and when to follow up, which can optionally be scheduled with an alert to the leader at the appropriate time. If a leader spends time with a particular operator, a log can be kept of what was discussed. In an example, if the leader learns that additional training or mentoring would be beneficial to an operator and provides the additional resources, measurements of the effect of the training on operator productivity can be measured in response to the intervention. In following a script and providing the script details including identification of the leader and operator and timing the script was conducted, the analytics engine can also correlate any quantifiable results from use of the script. Options can be provided for script interaction between leader and operator, such as alternatives in phrasing of question, and a correlation of the selected script with productivity to determine if a particular script has a measurable positive contribution to process health. Scripts can also include actionable items to provide operators with operational guidance, and data can be collected on the optimum duration, scheduling and time spent on each agenda item such that the huddle or meeting is lasting long enough to cover important things, and not too long so as to impede productivity. System tracking of how well the script is being used, how much time is spent on each agenda item, and other aspects of the huddle can be done using a camera, screen clicks (for an electronic presentation), button push, or other mechanism. Different mechanisms may also be tracked to provide guidance on what medium and/or scripts works best in any given team, individual, or organization environment. There are many options available for huddles that may be tried, such as, for example, visuals, graphics, photographs, charts, videos, lists, presenting data. Understanding which method of presentation has the greatest effect on organizational health can assist leaders and organizations to best understand their organizations and how their operators learn and can become more engaged in organization health improvements.

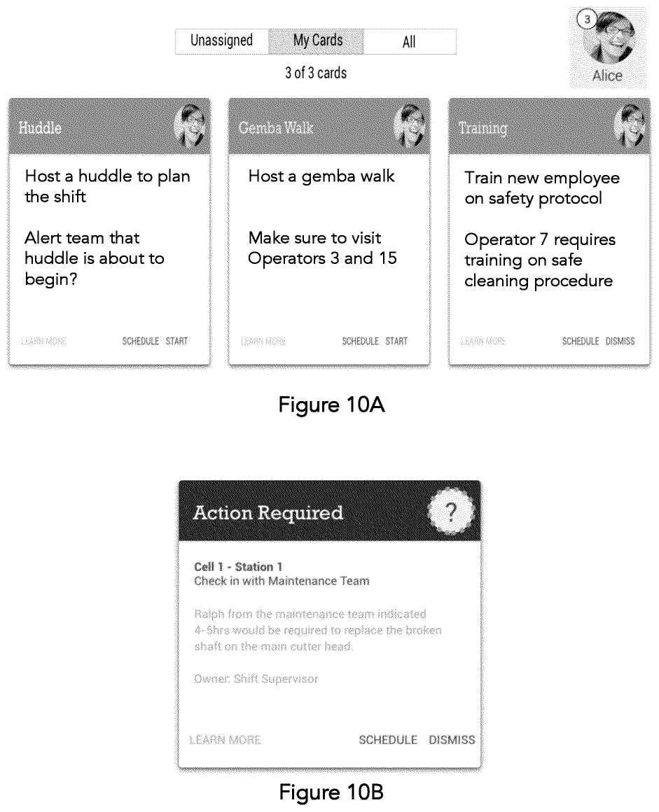

A task list or dashboard can be provided for leaders to identify tasks to be done, and enable a leader to assign tasks to operators and other team members, including themselves. Once all tasks are assigned the leader can begin working on their assigned tasks. Tasks can be further sorted into “unassigned”, “my cards” or “all cards”. Each card can have a different task to be done, and an option for leaders to distribute the card or assign the task to a different team member. FIG. 10A is an example set of leader action cards for non-urgent leader actions. FIG. 10B is an example urgent leader action card for an urgent leader action. The dashboard, action cards or task list can be presented on a computer screen or mobile device and can provide additional alerts such as alert sound, vibration, pop-up, or other alert, and can be queued to alert the leader depending on the urgency of the alert.

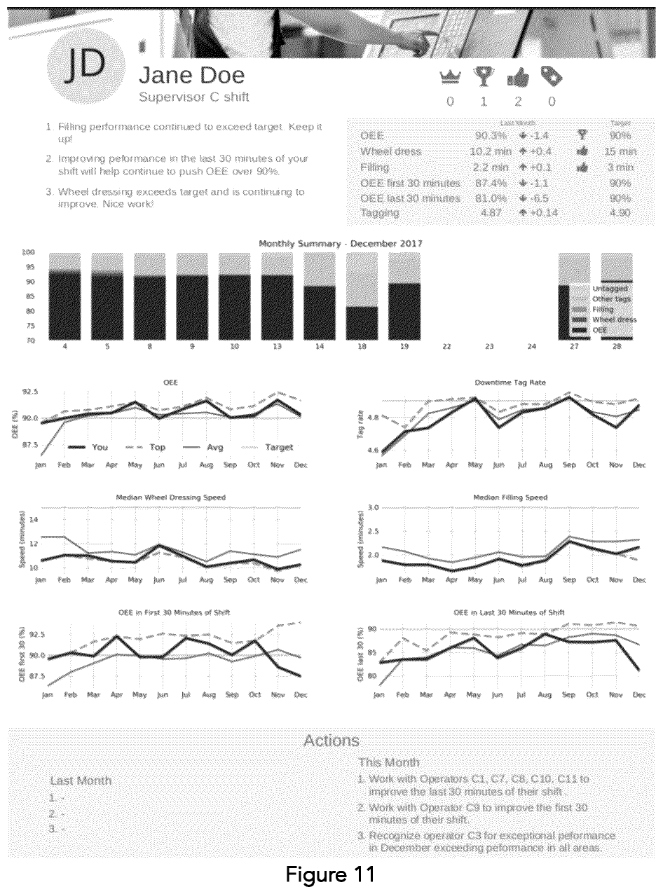

Process health and productivity data can be provided to leaders in the form of shift reports and other reports. FIG. 11 is an example leader performance report. The time that leaders spend reading and approving these reports can also be recorded for analysis in the analytics engine. By capturing leader behavior around time spent reading and understanding what happened on a shift or over a period of time in an operation further correlations can be made. Is leader reviewing previous shift or reports? Is leader acting on prescriptive analysis? Is leader looking at report to verify that report accurately records events? These questions can be answered by tracking the time and duration of leader interaction with reports, provide ownership and human accountability to the leader over the team performance, and encourage good data collection.

### EXAMPLE 1

### Investigating Operator Productivity

The present system and method was applied to a company that manufactures dental equipment and consumables. A machine tap on each manufacturing machine collected machine data related to machine rates and states for discrete periods of time. The machine tap also comprised a machine user interface to query the operator for context data requiring the selection of one or more tags pertaining to the state or operation of the machine. Correlation to each operator, shift, time of day, machine, and other context data was also collected for the same discrete period of time.

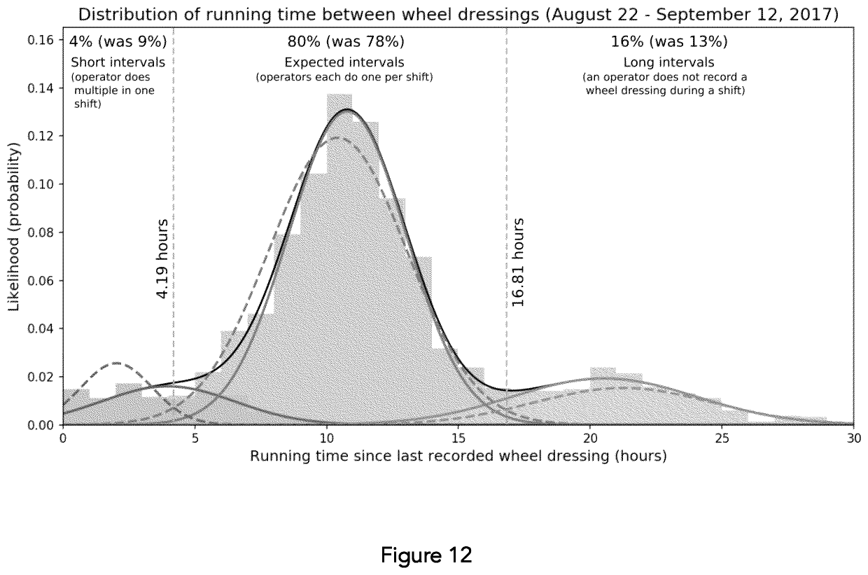

FIG. 12 is a graph showing distribution of running time between wheel dressings. To put this in context, each wheel dressing requires a machine slowdown and calibration, which reduces operating time for the machine. More and longer duration wheel dressings can therefore have a detrimental effect on productivity. Performance data on machine operation as well as machine notifications of filling and wheel dressing inputted by the operator through a machine tap were collected. The frequency and timing of wheel dressing for each operator was established and correlated with downtime and operator input tags. The machine and performance data collected on the team's productivity as displayed in FIG. 12 showed that a subset of operators were performing a wheel dressing task twice a shift, whereas the majority of operators were performing the same task once or not at all.

Using this data, the leader was tasked with going to the floor location of the short interval operators to observe the process, speak to that subset of operators, and investigate. Through respectful guided conversation the leader learned that these operators were having to do multiple wheel dressings for two main reasons: either the operator had not been thoroughly trained on how to use the machine, or the machine had an issue of not operating perfectly, or both. Some of the other operators who were doing one or no wheel dressings in a shift has also noticed an imperfection in the way the machine operated and had found a work around.

To address the lower functioning operators the leader took one or more of the following actions:
1. Had maintenance done on the machine to make sure it was in top working order
2. Provided the operator with training on the machine
3. Shared the work around found by the higher functioning operators with the whole team

As shown, the incidence of short intervals was reduced from 9% of wheel dressing to 4%. The spacing between wheel dressings is also more consistent. Together these changes resulted in a 40 hour gain in productivity of the team over the month, which for this company was equivalent to a gain in 30,000 units/year, or $50,000-$300,000 per year impact on productivity, depending on the unit being manufactured. Identification of a process inefficiency and directing the leader to perform a reflection meeting with operators avoided excess work for the operator, increasing the operator's competency at their machine and had a quantifiable impact on the bottom line of the company.

Although the present disclosure is directed to an augmented management system in a manufacturing environment, it would be clear to the skilled person that the same may be used in other environments and workplaces where leader location has an impact on organization health or worker health or productivity. It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined. Over time, improvement of algorithms will improve the accuracy and power to predict the opportunity cost for leader action and provide best practices recommendations for both leaders and other team members.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

1. An augmented management system comprising:
a leader location monitor for collecting leader location data in a manufacturing environment;
a machine tap for collecting machine data;
a database of performance data for storing the machine data and context data;
a database of leader behavior for storing the leader location data;
a prescriptive analytics engine for analyzing the leader location data and the performance data; and
an alert engine for providing an alert to the leader to guide leader behavior.

2. The system of claim 1, wherein the leader location data comprises at least one of leader location in the manufacturing environment, duration of time spent at the location, speed of movement through the manufacturing environment, path of movement through the manufacturing environment, time of movement, and identification of at least one other team member in the manufacturing environment.

3. The system of claim 1, wherein the alert is delivered to one or more of a laptop, smartphone, mobile device, augmented reality device, conversational voice assistant, or optical feedback device.

4. The system of claim 1, further comprising an input device for tagging the leader location data to provide additional information about leader behavior.

5. The system of claim 1, wherein the alert engine uses at least one of machine learning and artificial intelligence.

6. The system of claim 1, wherein the prescriptive analytics engine uses at least one of machine learning and artificial intelligence.

7. The system of claim 1, wherein the leader location monitor comprises a trackable leader mobile device and at least three anchor nodes in the manufacturing environment.

8. The system of claim 1, further comprising one or more team member location monitors.

9. The system of claim 1, where the alert is provided to the leader on one of a task list, action card, floor plan map, and queued audio list.

10. The system of claim 1, further comprising a leader action monitor for collecting leader action data.

11. A method for augmented management comprising:
collecting leader location data for a leader in a manufacturing environment;
collecting performance data for the manufacturing environment;
storing the leader location data and the performance data in at least one database;
analyzing the leader location data and the performance data in a prescriptive analytics engine; and
generating an alert to guide leader behavior, wherein the guidance results in a change to process health of the manufacturing environment.

12. The method of claim 11, wherein generating an alert sends out an alert in real-time.

13. The method of claim 11, wherein generating an alert comprises delivering an alert to one or more of a laptop, smartphone, mobile device, augmented reality device, conversational voice assistant, or optical feedback device.

14. The method of claim 11, further comprising recording leader reaction time for responding to the alert.

15. The method of claim 11, wherein the prescriptive analytics engine analyzes the leader location data and the performance data using at least one of machine learning and artificial intelligence.

16. The method of claim 11, further comprising tracking location of one or more team members in the manufacturing environment.

17. The method of claim 11, wherein the leader location data comprises at least one of leader location in the manufacturing environment, duration of time spent at the location, speed of movement through the manufacturing environment, path of movement through the manufacturing environment, time of movement, and identification of at least one other team member in the manufacturing environment.

18. The method of claim 11, further comprising:
collecting leader action data; and
analyzing the leader action data in the prescriptive analytics engine,
wherein the leader action data comprises at least one of time and timing of report reading, timing and duration of meetings, scripts used during meetings, amount of time spent on the manufacturing floor during a shift, time of huddle during shift, duration of huddle, amount of time spent on one-on-one mentoring, and amount of time in a huddle spent on particular aspects of process health.

19. The method of claim 11, further comprising limiting the number of generated alerts to below a daily threshold limit.

20. The method of claim 19, wherein the alert is generated based on threshold opportunity for the alert.
